(19) United States
(12) Patent Application Publication
(10) Pub. No.: US 2010/0193738 A1
(43) Pub. Date: Aug. 5, 2010

(54) ACTIVE OPTOCERAMICS WITH CUBIC CRYSTAL STRUCTURE, METHOD OF PRODUCTION OF THE OPTOCERAMICS, AND USES THEREOF

(76) Inventors: Ulrich Peuchert, Bodenheim (DE); Yvonne Menke, Mainz (DE); Yoshio Okano, Ibaraki (JP); Axel Engel, Ingelheim (DE)

Correspondence Address: MICHAEL J. STRIKER, 103 EAST NECK ROAD, HUNTINGTON, NY, 11743, US

(21) Appl. No.: 12/696,134

(22) Filed: Jan. 29, 2010

(30) Foreign Application Priority Data
Feb. 2, 2009 (DE) 10 2009 000 552.8

(51) Int. Cl. C09K 11/77; C04B 35/64; C04B 35/50

(52) U.S. Cl. 252/301.4 R; 264/654; 501/152

(57) ABSTRACT

The transparent polycrystalline optoceramic has single grains with a symmetric cubic crystal structure and at least one optically active center. The optoceramic has the following formula: A₂₊ₓB_{y}D_{z}E₇, wherein −1.15≦x≦0, 0≦y≦3, 0≦z≦1.6, and 3x+4y+5z=8, and wherein A is at least one trivalent rare earth cation, B is at least one tetravalent cation, D is at least one pentavalent cation, and E is at least one divalent anion. The method of making the optoceramic includes preparing a powder mixture from starting materials, pre-sintering, sintering and then compressing to form the optoceramic. Scintillator media made from the optoceramic are also described.

### CROSS-REFERENCE

The invention claimed and described herein below is also described in German Patent Application 10 2009 00 0552.8, filed on Feb. 2, 2009 in Germany. The aforesaid German Patent Application, whose subject matter is incorporated by reference thereto, provides the basis for a claim of priority of invention for the invention described and claimed herein below under 35 U.S.C. 119 (a) to (d). The copending US patent application, docket no. 4832, of the same title as above, contains subject matter related to this US patent application.

### BACKGROUND OF THE INVENTION

1. Field of the Invention and Introduction

The present invention relates to optoceramics, doped with activator elements, and having high transmissions, high densities and high effective atomic numbers. The activator elements are preferably chosen from the group of rare earth ions; titanium ions or transition metal ions are also possible. The materials are suitable to absorb high-energy radiation (preferably x-ray and gamma radiation as well as corpuscular radiation) and transform it to photons of visible light. These materials are therefore, for example, suited as scintillator media for e.g. medical imaging (CT, PET, SPECT or combined PET/CT systems), security (x-ray detectors) or can serve in object tracing or investigation (exploration, prospecting for resources). The crystallite grains, forming the materials of the present invention, have cubic crystal structures (point and space groups as well as atom layers are isotypic to those of the pyrochlore or fluorite minerals) or are clearly derivable from both mentioned minerals in terms of crystal structure.

In the present invention the term “optoceramic” refers to an essentially single phase, polycrystalline material of cubic symmetry and high transparency that is based on an oxide or other chalcogenide. Consequently, optoceramics are a special subgroup of ceramics. In this context “single phase” means that at least more than 95% of the material, preferably at least 97%, more preferably at least 99% and most preferably 99.5 to 99.9% of the material is present in the form of crystals of the target composition. The single crystallites are densely packed and densities, in relation to the theoretical densities, of at least 95%, preferably at least 98%, more preferably at least 99% are achieved. Hence, the optoceramics are almost free of pores.

Optoceramics differ from conventional glass ceramics in that the latter comprises a high proportion of amorphous glass phase next to the crystalline phase. Also, conventional ceramics do not have such high densities as optoceramics. Neither glass ceramics nor ceramics show the advantageous properties of optoceramics as represented by specific refractive indices, Abbe numbers, values of relative partial dispersions and, above all, the advantageous high transparencies for light in the visible and/or infrared wavelength regions.

Scintillator materials are active materials that absorb high-energy radiation directly or via a multitude of intermediate steps, wherein electron-hole pairs are generated. Their recombination leads to excitation of adjacent activator centers. The latter is thereby elevated into a metastable excited state. The relaxation of which leads, dependent on the choice of activator and host material, to emission of electromagnetic radiation in the energy range of near UV to near IR, i.e. 200 nm to 1500 nm, preferably 300 nm to 1100 nm (secondary radiation). This radiation is transformed into electric signals by suitable optoelectronic converters (photomultipliers or photodiodes). Areas of application are in the medical field (imaging and diagnostics), industrial inspection, dosimetry, nuclear medicine and high-energy physics as well as security, object tracing and exploration.

The requirements for detector materials for detection and conversion of high-energy radiation (x-ray and gamma radiation) to visible light are manifold:
high light yield and high energy resolution,
high transmission for secondary radiation (for coupling out the yielded visible light),
high x-ray or gamma radiation absorption efficiency,
low destruction or quenching of radiation
high chemical and refractive optical homogeneity,
good workability and true to form highly precise post-processibility of the scintillator material,
emission wavelength geared to the sensitivity of the detector,
short decay times, also for improvement of resolutions in time-of-flight experiments as well as for enabling faster scan velocities in order to keep the dose of radiation to the patient as low as possible and
low afterglow after extinction of excitation radiation.

Especially the aspects of high transmission as well as high x-ray and gamma radiation absorption cross sections are of extraordinary importance. Next, the material must be economically obtainable.

2. Description of the Related Art

Some CT-scintillators are known in the art, like for example (Y,Gd)₂O₃:Eu (abbreviated “YGO”) and Gd₂O₂S:Pr,Ce,F (abbreviated “GOS”). Both are used in the form of ceramics. Single crystal growth of big individual crystals is not possible or extremely expensive due to the very high melting and breeding temperatures (above 2000° C.). By sintering suitable powders, these compositions can be produced relatively cost-effectively at low temperatures significantly lower than 2000° C.

The problem with GOS material is its low symmetry of the crystalline phase (hexagonal arrangement of the crystallites). Because of the birefringent properties of each crystal grain in the densely sintered structure, any optical photon is subject to unwanted scattering. Highly transparent GOS ceramics are intrinsically not obtainable.

Eu:YGO, for example with the composition Eu:Y_{1.34}Gd_{0.66}O₃ is as far as the density is concerned considerably more disadvantageous than GOS (about 5.92 g/cm³). It is thus worse than GOS concerning absorption of incoming radiation. Additionally, GOS has a disadvantageously long decay time of about 1 ms (millisecond).

A sintered translucent ceramic for gamma ray imaging is described in U.S. Pat. No. 6,967,330; it has a stoichiometry of Ce:Lu₂SiO₅, however, the crystal structure is not cubic and sintering ceramics with high transparencies is not possible even with very small crystallite grains (along the lines of GOS).

A layered ceramic of the composition Ce:Gd₂Si₂O₇ (GPS) is described by Kamawura et al. (IEEE Conference 2008 Dresden 19.-25.10.2008, Proceedings p. 67). It is especially suitable for detection of neutrons. The material was produced as a single crystal and then pestled to obtain a powder. The particle size is 50 to 100 μm. The material is not cubic and can thus not be sintered to trans-parent ceramics.

As single crystal solution CdWO₄ is still in use. However, this material has critically high cleavage properties and is thus only obtainable with difficulties and unreliably. Further, toxic cadmium is used during production.

In his lecture (TCCA-33) during the 4^{th} Laser Ceramics Symposium (Nov. 10-14, 2008, Shanghai, China) J. Rabeau (Stanford University) described the production of transparent Ce:La₂Hf₂O₇ (LHO) ceramics for scintillator applications by hot pressing. By hot pressing good transparencies could not be achieved; furthermore, the transparent ceramic is not stable due to the high lanthanum amount and decomposes after some time as it reacts with the water in the air.

Single crystals of Ce:Lu₂Si₂O₇ (LPS) are described in Pidol et al.: “Scintillation properties of Ce:Lu₂Si₂O₇, a fast and efficient scintillator crystal”, J. Cond. Mat. (2003), 2091-2102. These crystals have monoclinic symmetry; highly trans-parent ceramics are not obtainable. The material shows short decay times (38 ns) and low afterglow. However, light yield and energy resolution are only moderate.

A measure for the x-ray absorption capability of a scintillation host is the effective atomic number Z_{eff}. The effective atomic number describes the average atomic number of a mixture of different substances. It can for example be calculated according to the following equation:

Z_{eff}=^{2,94}\sqrt{f₁×(Z₁)^{2,94}+f₂×(Z₂)^{2,94}+f₃×(Z₃)^{2,94}+ . . .}

wherein fₙ is the proportion of the total number of electrons that relates to the respective element and

Zₙ is the atomic number of the respective element.

As a further index the product of the density and the fourth power of the effective atomic number Z_{eff} is introduced. This index is proportional to the stopping power. Stopping power means the energy loss per wavelength unit of an incoming particle, for example measured in MeV.

Selected scintillation hosts known in the art have the following values:

| | | | | density × |
|---|---|---|---|---|
| | Type | density g/cm³ | Z_{eff} | Z_{eff}⁴ (×10⁶) |
| Y_{1.34}Gd_{0.66}O₃ | Ceramic | 5.92 | 48 | 33 |
| Gd₂O₂S | Ceramic | 7.34 | 59 | 91 |
| CdWO₄ | single crystal | 7.99 | 61 | 111 |
| Gd₃Ga₅O₁₂ | single crystal | 7.09 | 50 | 43 |
| Lu₂Si₂O₇ | single crystal | 6.23 | 61 | 84 |

Malkin, Klimin et al. (Phys. Rev. B 70, 075112 (2004)) and Klimin (Phys. Sol. State, 47(8), 1376-1380, 2005) report titanium-containing single crystalline pyrochlore phases comprising rare earth ions on the A-position. A variant of Yb³⁺:Y₂Ti₂O₇ was produced as polycrystalline sample. The work focuses on single crystals, ceramics are described, too. However, these are produced at too low temperatures so that they cannot be transparent. The compositions are unfavourable for scintillator systems because the emission wavelength of the Yb³⁺ ion is between 1000 nm and 1100 nm. The common optoelectronic converters in medical imaging system are not designed for such wavelengths.

Transparent polycrystalline pyrochlore phases are known from WO 2007/060816. Their application is in the field of passive optics. Therefore, introduction of active centers with absorptions or emissions in the visible light region (ca. 380 nm to 700 nm) is not possible or not desired.

Similar considerations apply to Schott's application DE 10 2007 022 048, wherein however only very small amounts of rare earth ions like Pr, Nd, Sm, Eu, Tb, Dy, Ho, Er and Tm in the range <100 ppm are allowed due to the respective applications.

In Ji et al. “Fabrication of transparent HfO₂ (40%)-Gd₂O₃:Eu ceramics from nanosized powders” (Electrochemical and Solid State Letters 8(7), H58-60, 2005) Eu-activated polycrystalline Gd₂O₃ is described which is stabilized by HfO₂. The composition of the ceramics complies with Gd_{1.5}Hf_{0.5}O_{3.25}=3Gd₂O₃*2HfO₂, converted into molar proportions the composition is about 60 mal % Gd₂O₃ and 40 mal % HfO₂. Its structure, however, is neither stably cubic nor isotypic to that of the pyrochlores at room temperature (defect structure derived from the fluorite structure). Potential application is in the field of medical diagnostics (CT detector).

So-called “transparent” ceramics of the composition La₂Hf₂O₇ (LHO) are known from Ji et al. “Fabrication of transparent La₂Hf₂O₇-ceramic from combustion synthesized powders”, Mat. Res. Bull. 40(3), 553-559 (2005). Therein, powders of the target composition are used which had been synthesized by combustion reactions. The ceramics obtained thereby are at most translucent and free of rare earth ions.

It is clear from the state of the art that the currently described materials do often not have a highly symmetric, cubic crystal structure (can therefore not be sintered to high transparency) and/or are in the form of a single crystal or a layer. This is undesirable. As far as symmetric structures, if applicable also polycrystalline, are proposed they often do not satisfy the requirements of active material. As far as pyrochlore or fluorite structures are proposed at all they do not comply with current requirements. The variants that are known so far are either not transparent or only translucent and/or the density and/or the effective atomic number are too low or production is difficult. In case of La-containing forms the respective powders are additionally very hygroscopic and are only very difficulty convertible into transparent ceramics. Ceramics having pyrochlore structure and containing high amounts of Ti must be subjected to thermal post-processing in order to eliminate coloration by Ti³⁺ created in the reducing manufacturing process.

### SUMMARY OF THE INVENTION

It is the object of the present invention to provide a polycrystalline optoceramic having high transparency, preferably as a scintillator material, which can be produced via powder routes, and thus cost-effectively and in high quality in terms of transmission of secondary radiation.

The material should have a density that is as high as possible, ideally >5.0 g/cm³, preferably >6.0 g/cm³, especially preferably >7.0 g/cm³, exceptionally preferably >7.5 g/cm³ and/or have a high effective atomic number or a high product of density and the fourth power of the effective atomic number. Further, the material should satisfy all requirements for use in scintillator devices.

The objects of the present invention are attained by the optoceramic, method and uses covered by the appended claims.

The objects are especially solved by optically transparent, polycrystalline optoceramics with a symmetric, cubic structure of the single grains with at least one optically active center, preferably selected from the group consisting of rare earth ions, transition metal ions and titanium ions, wherein the optoceramics can be described by the following general formula:

A₂₊ₓB_{y}D_{z}E₇,

wherein −1.15≦x≦0, 0≦y≦3, 0≦z≦1.6, and 3x+4y+5z=8 and A is at least one trivalent cation from the group of rare earth ions, B is at least one tetravalent cation, D is at least one pentavalent cation and E is at least one divalent anion.

It is especially preferred that −1.0≦x≦0, further preferred −0.55≦x≦0, more preferred −0.4≦x≦0, even more preferred −0.25≦x≦0, further preferred −0.1≦x≦0, further preferred −0.05≦x≦0, and most preferred −0.02≦x≦0. Further, it is preferred that x<0. It is especially preferred that x<−0.01.

Only such optoceramics are in accordance with this invention. Namely, the single grains according to the invention have symmetric, cubic structures. Meant are such cubic structures that are analogous to those of the minerals pyrochlore or fluorite, i.e. are unambiguously derivable from them in terms of crystal structure.

By observing the above-mentioned requirements, the particularly advantageous optoceramics of the present invention can be obtained. Especially the outstandingly advantageous transmission properties of the present optoceramics are achievable with the above-mentioned stoichiometries.

Pyrochlores are crystalline phases of cubic symmetry and can be modified in their crystal chemistry in multiple ways. Materials with pyrochlore structure have the general formula A₂³⁺B₂⁴⁺O₇ or A₃³⁺B⁵⁺O₇. The pyrochlore family is extraordinarily large. The crystal structure is cubic and accepts a multitude of isotypes and mixed valence substitution on the A-position as well as on the B-position. Depending on ion radii compositions of the stoichiometries A₂B₂E₇ or A₃DE₇ crystallize either in the orthorhombic weberite type, the monoclinic perowskite type, the cubic fluorite type or the cubic pyrochlore type. Only the two last mentioned scintillator materials are suitable in accordance with the present invention.

In accordance with the present invention such optoceramics are preferred that have an effective atomic number Z_{eff}≧50, preferably ≧52, especially preferred ≧57, exceptionally preferred ≧60. This is achieved by suitable combination of elements on the A- and B-positions.

A is preferably selected from the group consisting of Y, Gd, Yb, Lu, Sc, La and mixtures of these components. Further preferred A is selected from Y, Gd, Yb, Lu, Sc and mixtures of these components. Most preferred A is selected from Gd, Lu, Yb and mixtures of these components; exceptionally preferred A is selected from the group consisting of Gd, Lu and mixtures of these two components.

In accordance with the invention B is preferably selected from the group consisting of Zr, Ti, Hf, Sn, Ge and mixtures of these components. It is further preferred that B is selected from Zr, Ti, Hf and mixtures of these components. In a special embodiment B is selected from Zr, Hf and mixtures of these two components. In another preferred embodiment B is selected from Ti, Hf and mixtures of these two components.

In a further embodiment Ti is preferably present in amounts of up to 50,000 ppm and further preferred in an amount of up to 30,000 ppm (mass proportion). In such an amount Ti is functioning more as a sintering aid than as host material. If Ti shall be applied as a dopant, amounts in the range of from up to 5 atomic percent, preferably up to 3 atomic percent relating to the powder mixture of the starting material are preferred.

In a special embodiment the optoceramic according to the present invention comprises La as a secondary component on the A-position in an amount of up to 10 mol percent of the respective oxide or sulphide next to a main A component.

The component D in the optoceramic according to the present invention is preferably selected from Nb and Ta.

It is especially preferred that the optoceramic according to the present invention is in accordance with the stoichiometry A₂B₂E₇. It is further preferred that there is a surplus of the B component.

The E position in the optoceramic according to the present invention is preferably occupied by a chalcogene or a mixture of several chalcogenes. In a preferred embodiment E is oxygen. In an alternative embodiment E is a mixture of sulphur and oxygen. According to the present invention the content of sulphur in this mixture is preferably up to 36 atomic percent as long as the structure remains cubic.

The optoceramic according to the present invention preferably has a content of rare earth ions of more than 100 ppm (mass proportion).

La on the A position would also form cubic pyrochlore phases with suitable partners on the B position which would be transformable to transparent ceramics. However, La is too lightweight; furthermore, La-containing ceramics are critical in relation to chemical resistance of the material as well as in the process (hygroscopicity of the powders, quick agglomeration of nanoscale grains). However, a substitution in part of La for example in mixed crystal phases is allowed. Therein, La is applied in amounts of preferably up to 10 mol percent in relation to the oxide or sulphide.

Preferably, the optoceramics according to the present invention are scintillation media.

Hence, optically transparent, polycrystalline optoceramics, in accordance with the present invention, have a pyrochlore structure and at least one optically active center, wherein they can be described by the following general formula: A₂₊ₓB_{y}D_{z}E₇ and wherein −1.15≦x≦0, 0≦y≦3, 0≦z≦1.6, and 3x+4y+5z=8 and wherein A is at least one trivalent cation from the group of rare earth ions, B is at least one tetravalent cation, D is at least one pentavalent cation and E is at least one divalent anion.

It is especially preferred that −1.0≦x≦0, further preferred −0.55≦x≦0, more preferred −0.4≦x≦0, even more preferred −0.25≦x≦0, further preferred −0.1≦x≦0, further preferred −0.05≦x≦0, and most preferred −0.02≦x≦0. Further, it is preferred that x<0. It is especially preferred that x<−0.01.

Next to optoceramics containing phases of pure compounds, mixed crystal phases are also possible according to the present invention. Therein, a first A cation can be replaced by a second A cation in any arbitrary amount. Preferred is that up to 50 mol %, further preferred up to 40 mol % of the first cation are replaced by the second cation. Especially preferred, up to 25% of the first A cation are replaced by the second A cation. The same applies to the B and D positions.

The optically active center is preferably selected from the group consisting of rare earth ions, transition metal ions and titanium ions. Preferably, the active centers are selected from the group consisting of rare earth ions and titanium ions. It is most preferred that the optically active center is a rare earth ion.

The application of Yb is preferably done in such amounts that it occupies a regular A-position in the lattice. Therein, the proportion, expressed in mol %, of the oxide Yb₂O₃ is 33 mol %±20 mol %. Yb as activator center in small amounts of <5 mol % is not preferred, depending on an application.

Transparency in the visible means an internal transmittance (i.e. light transmission minus reflection losses) which is within a range, not containing an absorption band of the activator, having a width of at least 50 nm, for example a range from 700 to 750 nm within the visible light with wavelengths of 380 nm to 800 nm, of more than 25%, preferably more than 60%, preferably more than 70%, especially preferred more than 80%, further preferred more than 90% and especially preferred more than 95% at a sample thickness of 2 mm, preferably even at a sample thickness of 3 mm, especially preferred at a sample thickness of 5 mm. Only ceramics that fulfil these requirements are regarded as optoceramics according to the present invention.

In a preferred embodiment of the present invention the optoceramic is free of La. in comparison to the components in accordance with the present invention La has bad sintering properties because it is very hygroscopic. Further, La has a negative impact on the stopping power due to its low weight. Nevertheless, La can be used as a co-dopant in the optoceramic according to the present invention. In this case however the content is low in comparison to use of La on the A-position of the pyrochlore. On the A-position of the pyrochlore La₂O₃ had to be used in a molar amount of at least about 33 mol %. However, it is preferred according to the present invention that La₂O₃ is present in amounts only less than 20 mol %, preferably less than 10 mol % and most preferred to less than 5 mol % in the compositions according to the present invention. By observing these rules, the good sinterability and applicability as scintillator materials is conserved. Application of La as a co-dopant can become necessary in order to influence the properties of emitted light.

The components on the A-position are preferably used in the form of compounds with the stoichiometry A₂O₃, while the components on the B-position are preferably used in the form of compounds with the stoichiometry BO₂. The molar substance amounts are ideally at 33.3 mol A₂O₃ and 66.6 mol % BO₂. However, other mixing relations that nevertheless conserve the required cubic structure are also in accordance with the present invention. Therein, the substance amount of A₂O₃ can be between 13 mol % and 33.3 mol %, preferably between 23 mol % and 33 mol %, while the substance amount of BO₂ is between 66.6 mol % and 87 mol %, preferably between 67 mol % and 77 mol %. Especially preferred are ranges in which there is a surplus of BO₂.

The components of the D position are preferably used as compounds of the formula D₂O₅. Accordingly, the ideal molar substance amount in an optoceramic according to the present invention is 25 mol %. Further, mixing ratios in which D₂O₅ is present in a molar substance amount of 15 to 35 mol % of the optoceramic are also in accordance with the present invention.

According to a further embodiment of the present invention the optoceramic according to the present invention comprises Hf or Zr or Ti.

According to a particularly preferred embodiment of the present invention, the optoceramic according to the present invention has a composition that is selected from Gd₂Hf₂O₇, Yb₂Hf₂O₇, Lu₂Hf₂O₇ including respective mixed crystals with mixed A substitutes, like for example (Gd, Lu)₂Hf₂O₇ as well as respective zirconates or titanates.

Further preferred embodiments are selected from Gd₂(Hf, Zr)₂O₇ as well as respective Lu and Yb compounds; further non-stoichiometric substitutes like for example Gd_{1.6}Hf_{2.3}O₇ or Lu_{1.95}Hf_{2.04}O₇. Furthermore, combined mixed crystal phases like (Lu, Gd)_{1.98}(Zr, Hf)_{2.01}O₇ are especially preferred.

Substitution of several oxygens by several chalcogene anions, however not exceeding 4 of the 7 oxygens (S content: 4/11=36 atomic percent). The content of S in atomic percent xₛ is thus in the range of 0<xₛ<36 atomic percent. According to a preferred embodiment, the E position is completely occupied by S. Requirement for all combinations is however maintenance of cubic symmetry.

A preferred embodiment of the present invention refers to an optoceramic comprising rare earth ions in a content of at least 100 ppm. An optoceramic that is preferred according to the present invention comprises as an activator center one or more of the ions of the elements that are selected from the group consisting of Ce, Pr, Nd, Sm, Eu, Gd, Tb, Dy, Ho, Er and Tm. Particularly preferred are Eu, Ce, Pr, Nd, Tb and Sm. In a further particularly preferred embodiment of the present invention the optoceramic according to the present invention comprises Eu in the form of Eu³⁺ or Eu²⁺ or a mixture thereof.

Preferably, the density of the optoceramic according to the present invention is more than 5.0 g/cm³, further preferred more than 6.0 g/cm³, further preferred more than 7.0 g/cm³ and most preferred more than 7.5 g/cm³. The effective atomic number Z_{eff} of the optoceramic according to the present invention is preferably more than 50, further preferred more than or equal to 52, more preferred more than 57 and most preferred more than 60.

The optoceramics according to the present invention are characterized by an advantageously low decay time. Among others, it is the preferably short decay times that provides for application of the optoceramics in a way that is in accordance with the invention. Applications and uses that are in accordance with the invention are applications in scintillator media in measuring devices, preferably PET, CT and SPECT devices or in multifunctional devices PET/CT, PET/SPECT.

The objects of the present are further attained by a method of production of optoceramics according to the present invention. This method preferably comprises the following steps:

a. preparing a molded body from a powder mixture of the starting materials,
b. pre-sintering the molded body at temperatures between 500 and 1200° C.,
c. sintering of the pre-sintered molded body at temperatures between 1400 and 1900° C. in vacuum within a pressure range of between below 1 bar (i.e. slight depression) absolute and 10⁻⁷ mbar absolute, and
d. compressing the sintered molded body at temperatures between 1400 and 2000° C. at pressures between 10 and 300 MPa.

With the method of production of the present invention it is no longer necessary to conduct time consuming single crystal breeding. Single crystal breeding has the drawback that it takes place at very high temperatures of for example about 2000° C. or more for long periods. Thereby, high costs for energy occur that lead to single crystals not being suitable for mass production. The method according to the present invention however allows for drastic reduction of energy costs and simultaneously shortens production time such that mass production of the optoceramics according to the present invention is possible. The method of production according to the present invention is particularly suitable to produce molded bodies that are very close to net shape. Thereby, expensive post-processing steps can be omitted.

Normally, polycrystalline bodies have bad transmission properties as they comprise grain boundaries so that incoming light suffers more losses on these grain boundaries than it would be the case with single crystals. As a result, it is extremely difficult to provide suitable transparent, polycrystalline optoceramics that satisfy the strict requirements that have to be met by scintillator media.

It has now surprisingly been found that rare earth ions enhance sintering of ceramics according to the present invention. It is thus preferred according to the present invention that the method of production according to the present invention comprises addition of rare earth oxides or rare earth chalcogenides as sintering aids.

The sintering aids provide for production of a particularly high-value optoceramic and lead to an optoceramic that has particularly good transmission properties. This can be explained by the sintering aids forming eutectics with the other components of the powder mixture on the grain boundaries of the molded body so that the sintering process is faster and more thoroughly.

In order to facilitate formation of eutectics it is preferred that the sintering aids according to the present invention are not identical with the components that are the main components of the optoceramic. Hence, the sintering aids are preferably not those components that occupy positions A, B or D in the optoceramic.

By observing the prerequisites of the above-described method of production, optoceramics according to the present invention are obtained that have the mentioned outstanding properties.

### EXAMPLES

### 1. Example for the Production of a Transparent Ceramic of the Composition Ce:Gd₂Hf₂O₇ and Ce:Lu₂Hf₂O₇ by Uniaxial Compression (with Reactive Sintering)

Powder with primary particles having diameters of <1 μm of CeO₂, Gd₂O₃ or Lu₂O₃ and HfO₂ were weighed in the ratios according to the target composition. After addition of dispersing agent and binder, the batch is blended with ethanol and ZrO₂ balls in a ball mill during 12 h.

The grinding suspension was then dried on a hotplate.

The powder was afterwards compressed uniaxially into discs. The pressure conditions were at about 20 MPa, the compression time was a few seconds. The preformed compact was densified in a cold isostatic press, wherein the pressure was about 180 MPa. The pressure transferring medium was water.

Afterwards, the binder was burnt out in a first thermal step. The tempering time was 2.5 h and the temperature was 700° C. The burnt out green body was afterwards sintered in a vacuum sintering oven (depression: 10⁻⁵ mbar). Sintering to an almost pore-free body was done at higher temperatures of 1800° C. during 5 h.

During the following step of hot isostatic pressing (HIP) the closed pores were removed, the HIP conditions were 1780° C.-2 h-Ar-200 MPa.

Optically transparent and homogeneous bodies were obtained that could be further processed. The decay time was 66 ns (measured with LED at 336 nm) for the optoceramic 0.1 wt % Ce³⁺:Gd₂Hf₂O₇.

### 2. Example for the Production of a Transparent Ceramic of the Composition Eu:Yb₂(Zr,Ti)₂O₇ by Uniaxial Compression (with Reactive Sintering)

Powder with primary particles having diameters of <1 μm of Eu₂O₃, Yb₂O₃, ZrO₂ and TiO₂ were weighed in the ratios according to the target composition. Grinding took place in ethanol with ZrO₂ balls, wherein the grinding suspension was also mixed with binders and surface active agents. Grinding took place overnight.

The grinding suspension was then granulated with a spray dryer.

Afterwards the granulate was compressed uniaxially into discs. The pressure conditions were at about 10 MPa, the compression time was about one minute. The preformed compact was densified in a cold isostatic press, wherein the pressure was about 225 MPa. The pressure transferring medium was oil.

Afterwards, the binder was burnt out in a first thermal step. The tempering time and temperature was 2 h and 900° C. The burnt out green body was afterwards sintered in a vacuum sintering oven (depression: 10⁻⁶ mbar). Sintering to an almost pore-free body was done at higher temperatures between 1600 to 1800° C. during 5 h.

During the following step of hot isostatic pressing (HIP) the closed pores were removed, the HIP conditions were 1700° C.-10 h-Ar-200 MPa. After hot isostatic pressing, the sample was re-oxidized in a further thermal step (1000° C., 5 hours, O₂ stream).

Optically transparent and homogeneous bodies were obtained that could be further processed. The decay time was 1.5 ms for the optoceramic 0.1 wt % Eu³⁺:Yb₂(Zr,Ti)₂O₇.

### 3. Example for the Production of a Transparent Ceramic of the Composition Pr:Lu₂Zr₂O₇ by Hot Casting (with Reactive Sintering)

Powder with nanoscale primary particles (<100 nm in diameter) of Pr₂O₃, Lu₂O₃ and ZrO₂ were weighed in the ratio according to the target composition. In a heated ball mill the powder batch was mixed with the thermoplastic binder (mixture of 75 wt % paraffin and 25 wt % microscale wax) and the surface active agent siloxane polyglycol ether (single molecular covering of the ceramic particle surface) at 80° C. Therein the viscosity of the final slurry was 2.5 Pas at a solid particle content of 60 vol %. With a casting pressure of 1 MPa the slurry was cast directly into the plastic mould (hot casting). Stripping of the binder was done after demolding above the melting point of the wax used, wherein about 3 wt % remained in the green body in order to provide for dimension stability.

The binder and surfactants that remained in the green body were burnt out during the subsequent sintering process. Vacuum sintering was done with a heating rate of 300 K/h up to 1000° C. and a hold-time of 1 h followed by a further heating step to 1650° C. The vacuum conditions were at 10⁻⁵ to 10⁻⁶ mbar. HIP was done with a heating rate of 300 K/min to 1650° C. and a hold-time of 15 h at a pressure of 200 MPa.

Optically transparent and homogeneous bodies were obtained that could be further processed. The decay time was 45 ns for the optoceramic 0.5 wt % Pr³⁺:Lu₂Zr₂O₇.

### 4. Example for the Production of a Transparent Ceramic of the Composition Ce:Gd_{1.6}Hf_{2.3}O₇ or Ce:Lu_{1.95}Hf_{2.04}O₇ by Uniaxial Compression (with Reactive Sintering)

The process was essentially conducted as described in example 1.

Powder with primary particles having diameters of <1 μm of CeO₂, Gd₂O₃ or Lu₂O₃, and HfO₂ were weighed in the ratios according to the target composition (26 mol % Gd₂O₃ and 74 mol % HfO₂ or 32.3 mol % Lu₂O₃ and 67.7 mol % HfO₂). After addition of dispersing agent and binder, the batch is blended with ethanol and ZrO₂ balls in a ball mill during 12 h.

The grinding suspension was then dried on a hotplate.

The powder was afterwards uniaxially compressed into discs. The pressure conditions were at about 10 MPa, the compression time was 30 seconds. The preformed compact was densified in a cold isostatic press, wherein the pressure was about 200 MPa. The pressure transferring medium was water.

Afterwards, the binder was burnt out in a first thermal step. The tempering time and temperature was 3 h and 650° C. The burnt out green body was afterwards sintered in a vacuum sintering oven (depression: 10⁻⁵ mbar). Sintering to an almost pore-free body was done at higher temperatures of 1750° C. during 5 h.

During the following step of hot isostatic pressing (HIP) the closed pores were removed, the HIP conditions were 1780° C.-3 h-Ar-200 MPa.

Optically transparent and homogeneous bodies were obtained that could be further processed. The decay time was about 70 ns.

While the invention has been illustrated and described as embodied in active optoceramics with cubic crystal structure, their production and uses, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A transparent, polycrystalline optoceramic, single grains of which have a symmetric, cubic structure, with at least one optically active center, wherein the optoceramic has the following formula:
A₂₊B_{y}D_{z}E₇,
wherein −1.15≦x≦0, 0≦y≦3, 0≦z≦1.6, and 3x+4y+5z=8 and wherein A is at least one trivalent rare earth cation, B is at least one tetravalent cation, D is at least one pentavalent cation, and E is at least one divalent anion.

2. The optoceramic according to claim 1, wherein said cubic structure of said single grains is isotypic to that of pyrochlore or fluorite, or is unambiguously derivable therefrom in terms of crystal structure.

3. The optoceramic according to claim 1, wherein the at least one optically active center is selected from the group consisting of rare earth ions, transition metal ions, and titanium ions.

4. The optoceramic according to claim 1, wherein A is selected from the group consisting of Y, Gd, Yb, Lu, Sc, La and mixtures thereof.

5. The optoceramic according to claim 1, wherein A is selected from the group consisting of Y, Gd, Yb, Lu, Sc and mixtures thereof.

6. The optoceramic according to claim 1, wherein A is Gd, Lu or a mixture of Gd and Lu.

7. The optoceramic according to claim 1, wherein B is selected from the group consisting of Zr, Ti, Hf, Sn, Ge and mixtures thereof.

8. The optoceramic according to claim 1, wherein B is selected from the group consisting of Zr, Ti, Hf and mixtures thereof.

9. The optoceramic according to claim 1, wherein B is selected from the group consisting of Zr, Hf and mixtures thereof.

10. The optoceramic according to claim 1, wherein B is selected from the group consisting of Ti, Hf and mixtures thereof.

11. The optoceramic according to claim 1, containing Ti in an amount from more than 100 ppm to 30,000 ppm per weight unit.

12. The optoceramic according to claim 1, containing an oxide of La in an amount of up to 10 mol %.

13. The optoceramic according to claim 1, wherein D comprises Nb and/or Ta.

14. The optoceramic according to claim 1, having a stoichiometry defined by A₂B₂E₇.

15. The optoceramic according to claim 1, having an effective atomic number of more than 50.

16. The optoceramic according to claim 1, wherein E is a chalcogene or a mixture of chalcogenes.

17. The optoceramic according to claim 1, wherein E is oxygen.

18. The optoceramic according to claim 1, wherein E is a mixture of sulphur and oxygen with a sulphur content of up to 36 atomic percent.

19. The optoceramic according to claim 1, comprising more than 100 ppm of rare earth ions.

20. The optoceramic according to claim 1, containing an activator center, and wherein said activator center comprises one or more element selected from the group consisting of Ce, Pr, Nd, Sm, Eu, Gd, Tb, Dy, Ho, Er and Tm.

21. The optoceramic according to claim 1, containing an activator center, and wherein said activator center comprises one or more element selected from the group consisting of Ce, Pr, Nd and Eu.

22. The optoceramic according to claim 1, having a density of more than 5 g/cm³.

23. A method of producing a transparent polycrystalline optoceramic, single grains of which have a symmetric, cubic structure, with at least one optically active center, said method comprising the steps of:
a) preparing a molded body from a powder mixture of starting materials required for making the optoceramic;
b) pre-sintering the molded body at temperatures between 500 and 1200° C. to form a pre-sintered molded body;
c) sintering the pre-sintered molded body at temperatures between 1400 and 1900° C. in vacuum within a pressure range of between below 1 bar absolute and 10⁻⁷ mbar absolute to form a sintered molded body, and
d) compressing the sintered molded body at the temperatures between 1400 and 2000° C. with a pressure between 10 and 300 MPa;
wherein the optoceramic has the following formula:
A₂₊ₓB_{y}D_{z}E₇,
wherein −1.15≦x≦0, 0≦y≦3, 0≦z≦1.6, and 3x+4y+5z=8 and wherein A is at least one trivalent rare earth cation, B is at least one tetravalent cation, D is at least one pentavalent cation, and E is at least one divalent anion.

24. A scintillator medium comprising a transparent, polycrystalline optoceramic according to claim 1.

25. A scintillator medium in medical imaging, comprising a transparent, polycrystalline optoceramic according to claim 1.

26. A scintillator medium in the security field, comprising a transparent, polycrystalline optoceramic according to claim 1.

27. A scintillator medium in an X-ray scanner, comprising a transparent, polycrystalline optoceramic according to claim 1.

28. A scintillator medium in the field of resources exploration, comprising a transparent, polycrystalline optoceramic according to claim 1.
